(19) United States
(12) Patent Application Publication
(10) Pub. No.: US 2019/0177954 A1
(43) Pub. Date: Jun. 13, 2019

(54) IMPLEMENT CUTTING EDGE WITH BRAZED WHITE CAST IRON TEETH

(71) Applicant: CATERPILLAR INC., Peoia, IL (US)

(72) Inventors: Thomas Marshall CONGDON, Dunlap, IL (US); Nathan BJERKE, Peoria, IL (US)

(73) Assignee: CATERPILLAR INC., Peoria, IL (US)

(21) Appl. No.: 15/837,439

(22) Filed: Dec. 11, 2017

(51) Int. Cl. E02F 9/28; B23K 1/008; B23K 33/00

(52) U.S. Cl. CPC E02F 9/2883; B23K 33/00; B23K 1/008; E02F 9/2808

(57) ABSTRACT

A cutting edge component for a work tool on an earth-moving machine may include a longitudinally-extending wear component and a support surface connectable to a moldboard of the earth-moving machine. The wear component may include at least one wear portion connected to the support surface, and the at least one wear portion may form at least one ground engaging edge. The at least one wear portion may include a mild steel body and a plurality of longitudinally-spaced white cast iron teeth vacuum brazed along a distal, ground engaging edge of the mild steel body. The plurality of teeth may each be shaped with two intersecting substantially planar surfaces arranged to mate with at least a surface extending between the distal, ground engaging edge and at least one of a rearward-facing surface of the mild steel body and a front-facing surface of the mild steel body on at least one of a side of the mild steel body facing away from a direction of travel of the machine and a side of the mild steel body facing in the direction of travel of the machine to form a brazed joint. Each tooth may include a material directing feature defined in a front-facing surface of each tooth when the tooth is brazed to the mild steel body.

### TECHNICAL FIELD

The present disclosure relates generally to an implement cutting edge, and more particularly, to an implement cutting edge with brazed white cast iron teeth.

### BACKGROUND

Machines, for example motor graders, dozers, wheel loaders, and excavators are commonly used in material moving applications. These machines include a ground engaging tool having a cutting edge component configured to contact the material. For example, motor graders are typically used to perform displacement, distribution and leveling of material, such as rock and/or soil. The motor graders may move the ground engaging tool over the ground so that the cutting edge component engages with the rock and/or soil so as to displace, distribute, or level the rock and/or soil.

During use of the cutting edge component, the material may abrade the cutting edge component, causing it to erode away. Accordingly, the cutting edge component may be removably attached to the ground engaging tool and replaced on a periodic basis. Conventional cutting edge components may be formed as a single plate of constant thickness. Such conventional cutting edge components may be relatively costly to manufacture and relatively difficult to handle due to their weight. The cutting edges on large motor graders and similar equipment experience very high rates of wear. Therefore, customers of such heavy duty equipment are seeking solutions that provide significant improvements in the wear life of the cutting edges while minimizing associated cost increases.

A wear component for use on an excavator is described in U.S. Pat. No. 9,027,266 (the '266 patent) issued to Maher et al. Specifically, the wear component of the '266 patent includes a shell formed from a tough metal such as carbon steel and an inner body formed from an abrasion resistant metal such as a chromium white iron. The shell is provided with cross portions extending through the inner body, with the cross portions being made of the tough metal. While the wear component of the '266 patent may strengthen the overall toughness and abrasion resistance of a work tool on earth moving equipment, the configuration of the shell and complexities in the process of joining the shell to a work tool may be prohibitively expensive and result in excessive downtime during repair or replacement of the wear component.

The disclosed cutting edge component with brazed white cast iron teeth is directed to overcoming one or more of the problems set forth above and other problems associated with conventional implement cutting edges.

### SUMMARY

In one aspect, the present disclosure is directed to a cutting edge component for a work tool on an earth-moving machine. The cutting edge component may include a longitudinally-extending wear component and a support surface connectable to a moldboard of the earth-moving machine, wherein the wear component includes at least one wear portion connected to the support surface, and the at least one wear portion forms at least one ground engaging edge. The at least one wear portion may include a mild steel body and a plurality of longitudinally-spaced white cast iron teeth vacuum brazed along a distal, ground engaging edge of the mild steel body, the plurality of teeth each being shaped with two intersecting substantially planar surfaces arranged to mate with at least a surface extending between the distal, ground engaging edge and at least one of a rearward-facing surface of the mild steel body and a front-facing surface of the mild steel body on at least one of a side of the mild steel body facing away from a direction of travel of the machine and a side of the mild steel body facing in a direction of travel of the machine to form a brazed joint. Each tooth may also include a material directing feature defined along a front-facing surface of each tooth when the tooth is brazed to the mild steel body.

In another aspect, the present disclosure is directed to a wear component for a work tool on an earth-moving machine. The wear component may include at least one wear portion including at least one ground engaging edge, and the at least one wear portion may include a mild steel body and a plurality of longitudinally-spaced white cast iron teeth vacuum brazed along the at least one ground engaging edge. The plurality of teeth may each be shaped with two intersecting substantially planar surfaces arranged to mate with at least a surface extending between the at least one ground engaging edge and at least one of a rearward-facing surface of the mild steel body and a front-facing surface of the mild steel body on at least one of a side of the mild steel body facing away from a direction of travel of the machine and a side of the mild steel body facing in the direction of travel of the machine to form a brazed joint. Each tooth may also include a material directing feature defined in a front-facing surface of each tooth when the tooth is brazed to the mild steel body.

In another aspect, the present disclosure is directed to a method of forming a cutting edge component for a work tool on an earth-moving machine. The method may include preparing a main body of an existing cutting edge component for vacuum brazing and casting a plurality of white cast iron teeth. Each of the plurality of teeth may be shaped with two intersecting planar surfaces that form an angle with each other arranged to mate with at least a surface extending between a distal, ground engaging edge and at least one of a rearward-facing surface of the main body and a front-facing surface of the main body. The method may further include vacuum brazing the plurality of white cast iron teeth along the distal, ground engaging edge of the main body.

### BRIEF DESCRIPTION OF THE DRAWINGS

FIG. 1 is a side view of a machine, according to an exemplary embodiment;

FIG. 2 is a front view of a cutting edge component connected to a moldboard assembly of the machine of FIG. 1;

FIG. 3 is a side view of the cutting edge component and the moldboard assembly of FIG. 2;

FIG. 4 is a front view of a portion of an exemplary cutting edge component mounted on a support surface of a moldboard;

FIG. 5 is a front view of a portion of another exemplary cutting edge component mounted on a support surface of a moldboard;

FIG. 6 is a front view of a portion of yet another exemplary cutting edge component mounted on a support surface of a moldboard;

FIG. 7 is a front view of a section of the exemplary cutting edge component of FIG. 4;

FIG. 8 is a front view of a section of the exemplary cutting edge component of FIG. 5;

FIG. 9 is a front view of a section of the exemplary cutting edge component of FIG. 6;

FIG. 10 is a perspective view of an exemplary tooth for brazing to a distal edge of a cutting edge component;

FIG. 11 is a side elevation view of the exemplary tooth of FIG. 10;

FIG. 12 is a top plan view of the exemplary tooth of FIG. 10;

FIG. 13 is a front elevation view of the exemplary tooth of FIG. 10;

FIG. 14 is a front view of a cutting edge component connected to a moldboard assembly of the machine of FIG. 1;

FIG. 15 is a side view of the cutting edge component and the moldboard assembly of FIG. 14;

FIG. 16 is a front view of a portion of an exemplary cutting edge component mounted on a support surface of a moldboard;

FIG. 17 is a front view of a portion of another exemplary cutting edge component mounted on a support surface of a moldboard;

FIG. 18 is a front view of a portion of yet another exemplary cutting edge component mounted on a support surface of a moldboard;

FIG. 19 is a front view of a section of the exemplary cutting edge component of FIG. 16;

FIG. 20 is a front view of a section of the exemplary cutting edge component of FIG. 17;

FIG. 21 is a front view of a section of the exemplary cutting edge component of FIG. 18;

FIG. 22 is a front elevation view of an exemplary tooth for brazing to a distal edge of a cutting edge component;

FIG. 23 is a side elevation view of the exemplary tooth of FIG. 22;

FIG. 24 is a perspective view of the exemplary tooth of FIG. 22; and

FIG. 25 is an end view of the exemplary tooth of FIG. 22.

### DETAILED DESCRIPTION

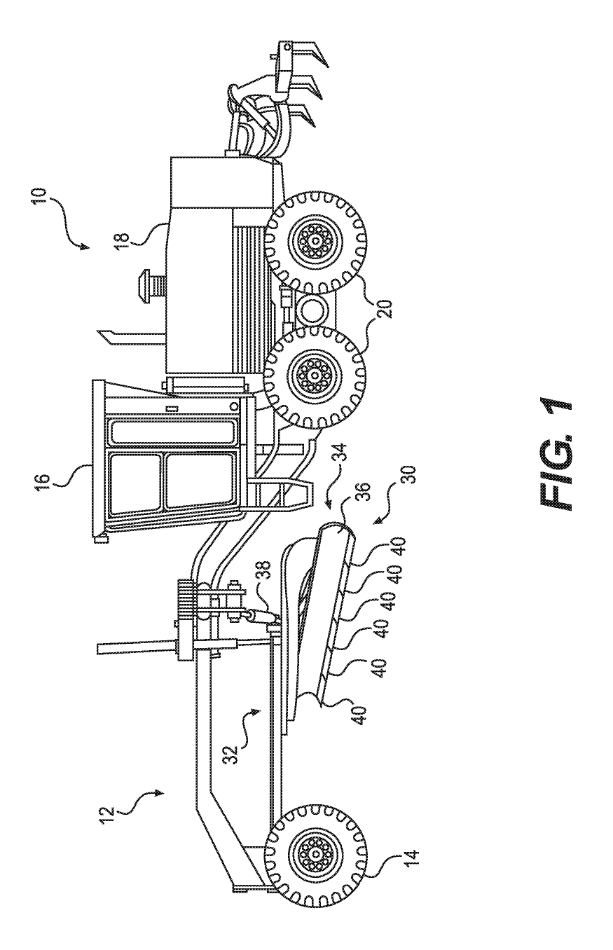

An exemplary embodiment of a machine 10 is illustrated in FIG. 1. The machine 10 may be, for example, a motor grader, a backhoe loader, an agricultural tractor, a wheel loader, a skid-steer loader, a dozer, an excavator, or any other type of machine known in the art. As a motor grader, the machine 10 may include a frame assembly 12. The frame assembly 12 may include a pair of front wheels 14 (or other traction devices) and may support an operator station 16. The frame assembly 12 may also include one or more compartments 18 for housing a power source (e.g., an engine) and associated cooling components. The power source may be operatively coupled to one or more pairs of rear wheels 20 (or other traction devices) for propulsion of the machine 10.

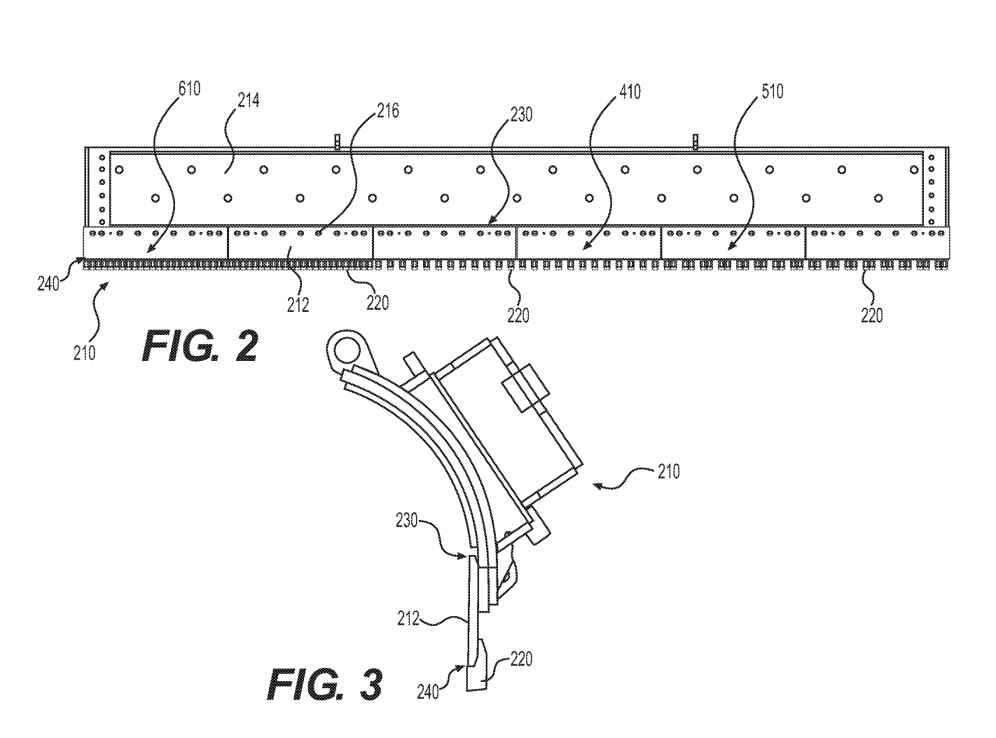

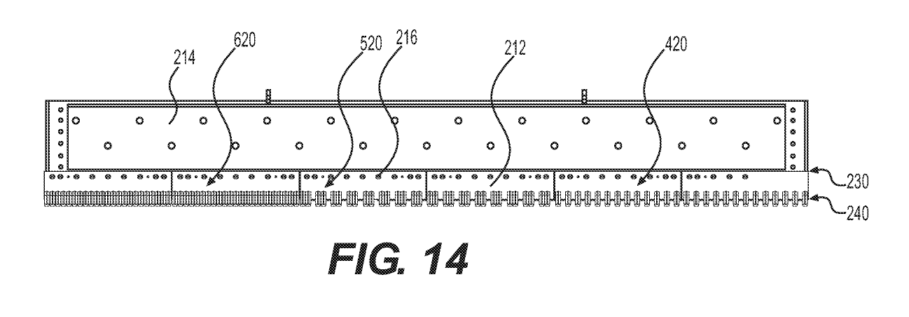

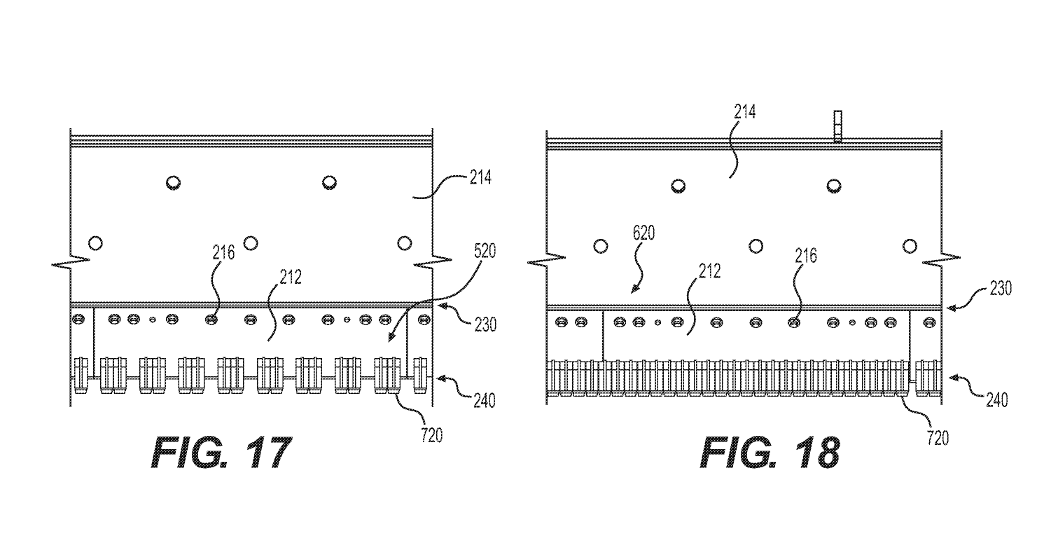

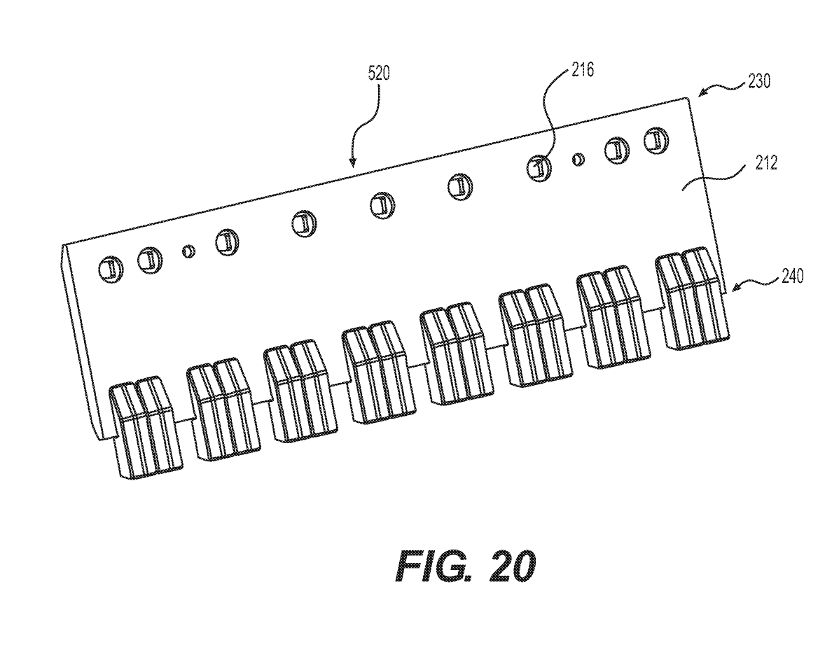

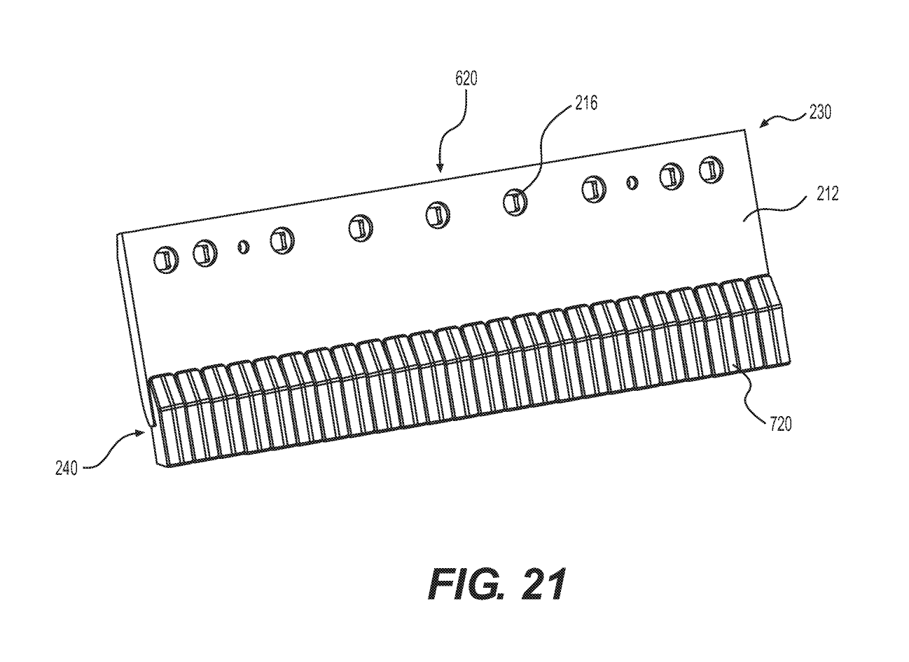

The machine 10 may also include one or more ground engaging tools 30. The ground engaging tool(s) 30 may include one or more wear components, such as one or more cutting edge components 40. In the case of a motor grader, as shown in FIG. 1, the ground engaging tool 30 may include a plurality of the cutting edge components 40 (e.g., six cutting edge components). Alternatively, other numbers of cutting edge components 40 may be provided, such as from one to eight cutting edge components, depending on the application. FIGS. 2-9 illustrate additional alternative embodiments of wear components 212 attached along a distal edge of a support surface 214, such as exemplary cutting edge components 410, 510, 610. FIGS. 14-25 illustrate alternative embodiments of wear components 212 attached along a distal edge of support surface 214, with teeth 720 brazed along a distal, ground-engaging edge 240 of wear component 212 and a front-facing surface of wear component 212.

In the embodiment of the motor grader shown in FIG. 1, the ground engaging tool 30 may include a drawbar-circle-moldboard (DCM) assembly 32 with a moldboard assembly 34 (or other mounting assembly) including a support surface 36. The cutting edge components 40 may be removably attached to the support surface 36. The DCM assembly 32 may be operatively connected to and supported by the frame assembly 12 or by another portion of the machine 10. The DCM assembly 32 may control the movement of the moldboard assembly 34 and therefore also the movement of the cutting edge components 40 mounted to the support surface 36 of the moldboard assembly 34. The DCM assembly 32 may also be supported by a hydraulic ram assembly 38 that controls the movement of the DCM assembly 32. As a result, the DCM assembly 32 and/or the hydraulic ram assembly 38 may control one or more of a vertical, horizontal, or pivotal movement of the moldboard assembly 34 and the cutting edge components 40 mounted to the support surface 36 of the moldboard assembly 34. Alternatively, different mechanical and/or hydraulic arrangements, e.g., other than the DCM assembly 32 and/or hydraulic ram assembly 38 described above, may be provided to allow for movement of the cutting edge components 40.

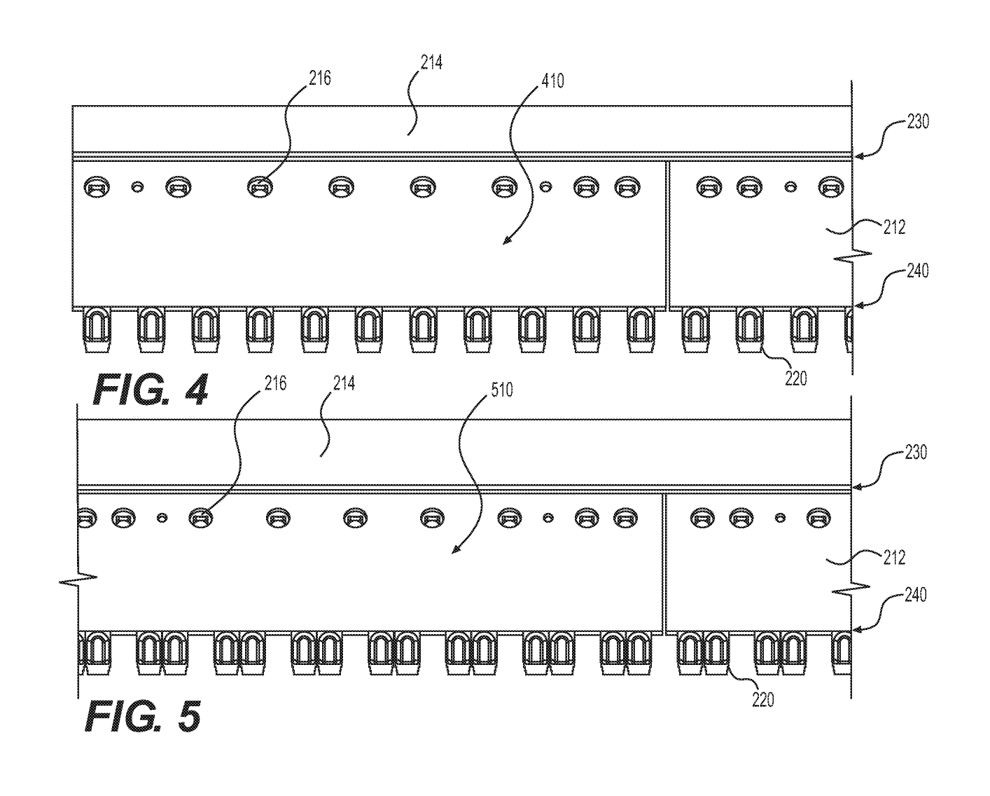

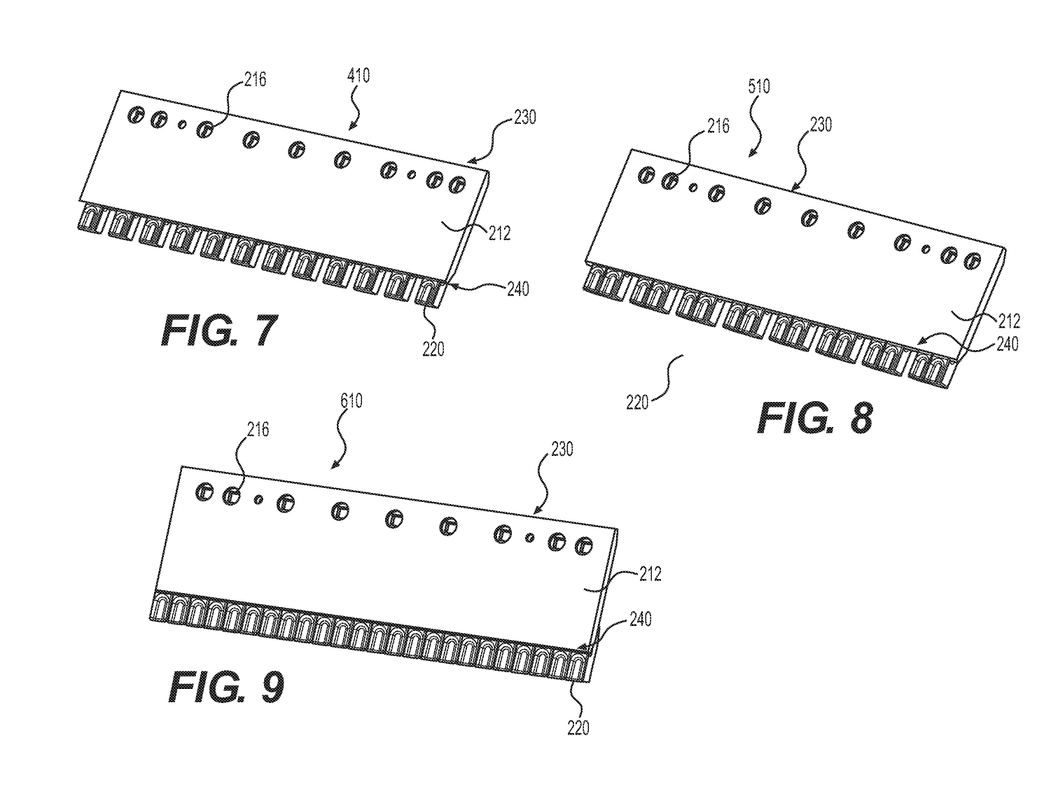

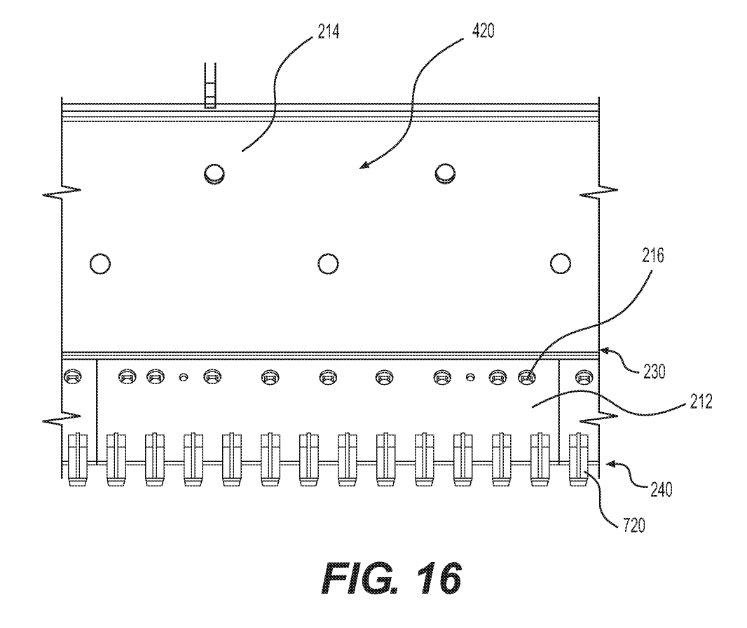

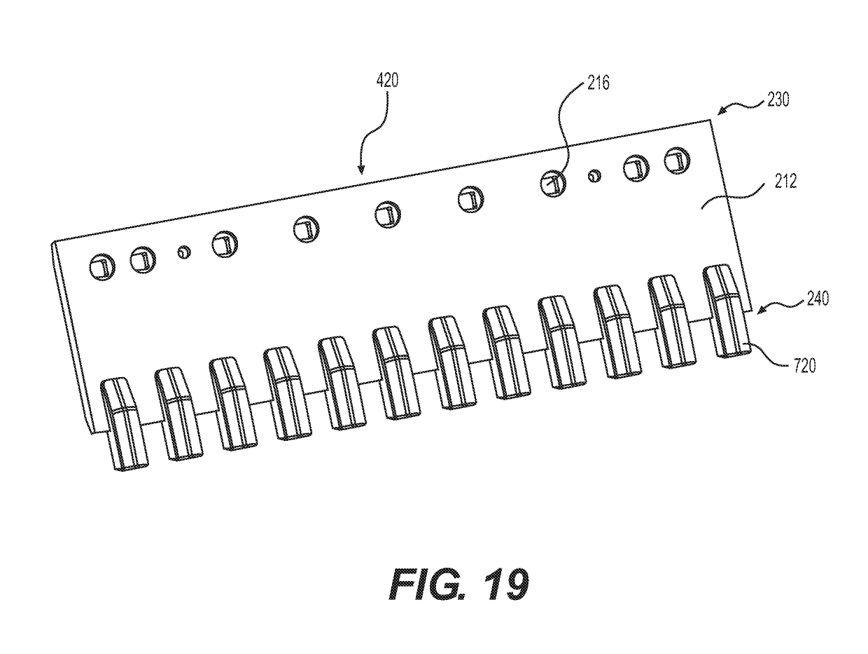

FIGS. 2-6 show exemplary embodiments of wear components 212 mounted to a support surface 214 of a moldboard assembly using multiple fasteners 216. The support surface 214 and/or portions of the wear components 212 may be flat or curved. FIGS. 7-9 show the exemplary cutting edge components 410, 510, 610, of FIGS. 4-6, respectively, removed from support surface 214. FIGS. 14-18 show further exemplary embodiments of wear components 212 mounted to a surface 214 of a moldboard assembly using multiple fasteners 216. FIGS. 19-21 show the exemplary cutting edge components 420, 520, 620, of FIGS. 16-18, respectively, removed from support surface 214. The term “longitudinal”, as used herein, refers to a dimension generally lengthwise with respect to each cutting edge component. FIG. 2 illustrates an exemplary implementation of a moldboard assembly, with the wear components 212 including two exemplary cutting edge components 610 connected along a longitudinal extent of a left-hand portion of support surface 214, two exemplary cutting edge components 410 connected along a longitudinal extent of a center portion of support surface 214, and two exemplary cutting edge components 510 connected along a longitudinal extent of a right-hand portion of support surface 214. FIG. 14 illustrates an exemplary implementation of a moldboard assembly, with the wear components 212 including two exemplary cutting edge components 620 connected along a longitudinal extent of a left-hand portion of support surface 214, two exemplary cutting edge components 520 connected along a longitudinal extent of a center portion of support surface 214, and two exemplary cutting edge components 420 connected along a longitudinal extent of a right-hand portion of support surface 214. In various alternative embodiments, a moldboard assembly may include different arrangements of cutting edge components with different features. The term “lateral”, as used herein, refers to a dimension generally extending between a proximal end or proximal edge 230 and a distal, ground engaging edge 240 of each cutting edge component. The proximal edge 230 and the distal, ground engaging edge 240 may extend generally longitudinally as shown. In an embodiment, the length of each cutting edge component along the longitudinal direction may range from approximately 24 inches to approximately 92 inches, and the length of a cutting edge component along the lateral direction may range from approximately 8 inches to approximately 16 inches. In one exemplary embodiment, a cutting edge component may be approximately 48 inches longitudinally and approximately 16 inches laterally.

The terms “distal” and “proximal” are used herein to refer to the relative positions of components or features of the exemplary cutting edge components along the lateral dimension. When used herein, “distal” refers to one end of a cutting edge component in the lateral dimension, e.g., the ground engaging edge of a cutting edge component. In contrast, “proximal” refers to the end of a cutting edge component that is opposite the distal end in the lateral dimension, e.g., the proximal edge 230 of each cutting edge component 410, 510, 610, as shown in FIGS. 4-6, and the proximal edge 230 of each cutting edge component 420, 520, 620, as shown in FIGS. 16-18, along which each cutting edge component is joined to support surface 214 with multiple fasteners 216.

While the cutting edge components shown in FIGS. 4-9 and 16-21 may be positioned substantially at right angles to the normal direction of travel of each cutting edge component, a cutting edge component may be oriented at a different angle relative to the direction of travel and/or curved. The terms “front” and “rear” are also used herein to refer to the relative positions and features of the components of the exemplary cutting edge components. When used herein, “front” and “front-facing” refers to one side of a cutting edge component positioned near the forward side of the cutting edge component with respect to the direction of travel of the machine 10. In contrast, “rear” and “rearward-facing” refers to the side of a cutting edge component that is opposite the front side. As shown in FIGS. 4-6 and 16-18, the rearward-facing side of wear component 212 may be the side that is connected to or proximal to the support surface 214 of the ground engaging tool to which the cutting edge component is mounted.

Each cutting edge component may be replaceable to help ensure productivity and/or efficiency of the machine 10. For example, each cutting edge component 410, 510, 610, 420, 520, 620 may be removably connected to the support surface 214 of a ground engaging tool by way of one or more fasteners 216, such as bolts, inserted through one or more mounting holes formed along a longitudinal extent of a portion of each cutting edge component near proximal edge 230.

An exemplary cutting edge component 410 is shown in FIG. 4 mounted to support surface 214 of a ground engaging tool. A plurality of teeth 220 may be connected along distal, ground engaging edge 240 of the main body of cutting edge component 410 to enhance the wear life and surface penetration performance of the cutting edge component. In the embodiments shown in FIGS. 2-13, teeth 220 are configured such that they may be connected along distal, ground engaging edge 240 of the main body of cutting edge components 410, 510, 610, with a brazing surface of each tooth 220 extending along a portion of a rearward-facing side of wear component 212. In the alternative embodiments shown in FIGS. 14-25, teeth 720 are configured such that they may be connected along distal, ground engaging edge 240 of the main body of cutting edge components 420, 520, 620, with a brazing surface of each tooth 720 extending along a portion of a front-facing side of wear component 212.

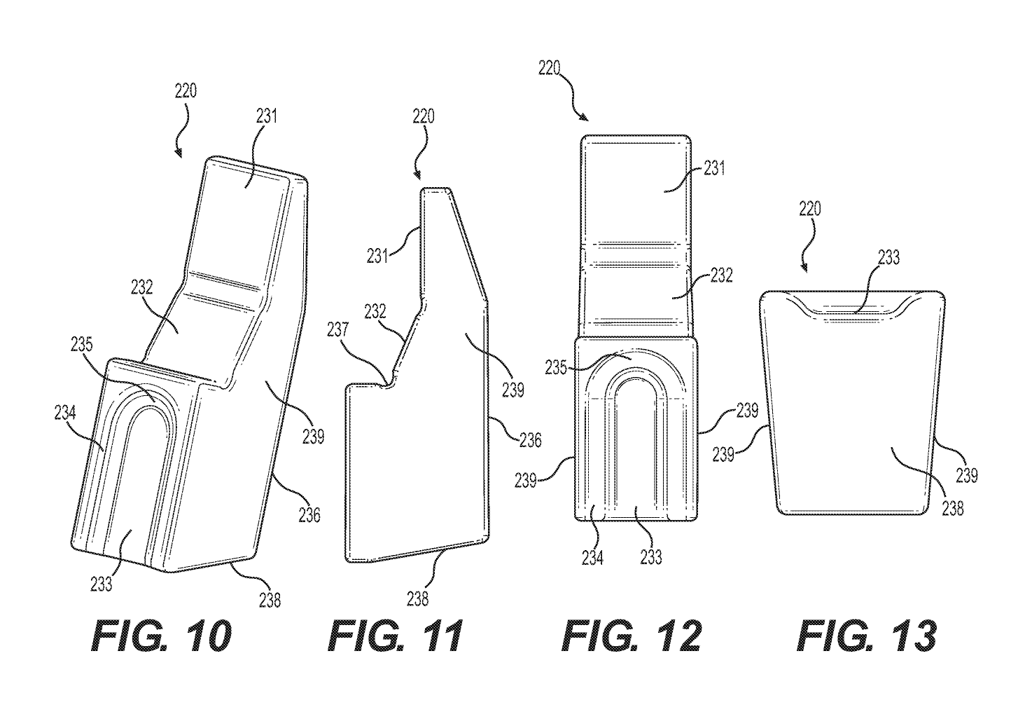

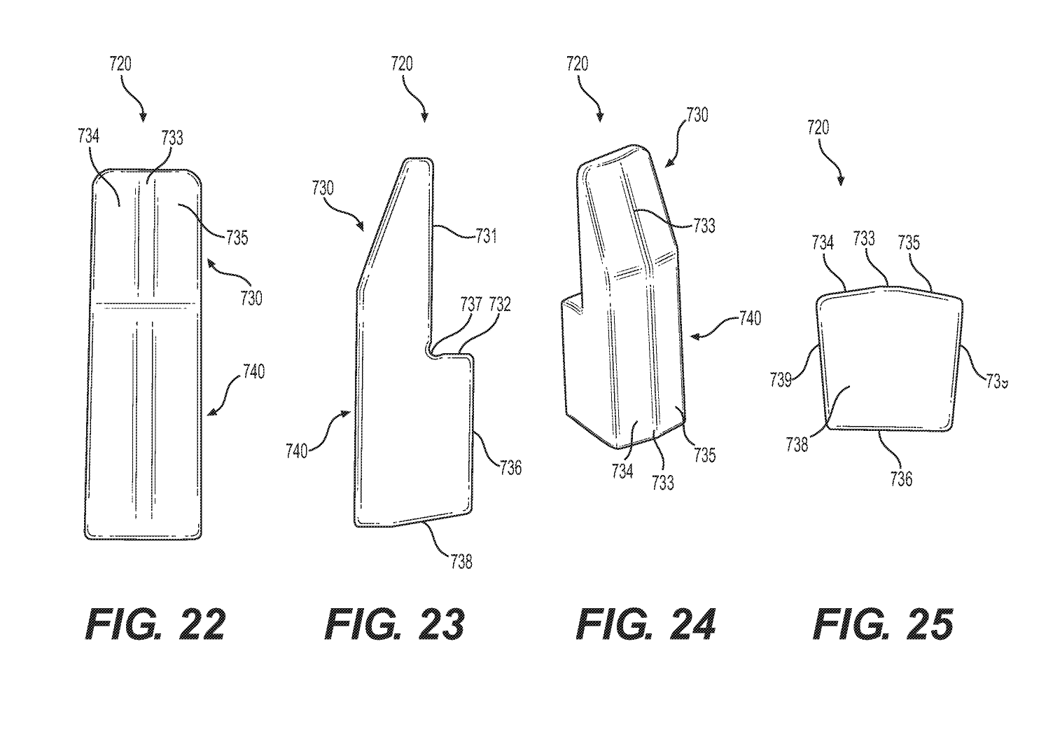

The main body of cutting edge component 410, 510, 610, 420, 520, 620 may be an existing cutting edge part made from a mild steel. Mild steel is a type of carbon steel with a low amount of carbon, and is also known as “low carbon steel”. Although ranges vary depending on the source, the amount of carbon typically found in mild steel is 0.05% to 0.25% by weight, whereas higher carbon steels are typically described as having a carbon content from 0.30% to 2.0% by weight. The mild steel is typically more ductile, machinable, and weldable than high carbon and other steels, but is difficult to harden and strengthen through heating and quenching. Improved wear resistance of the cutting edge component is obtained according to various embodiments of this disclosure by vacuum brazing teeth 220, 720 made from superior wear resistant materials along the distal, ground engaging edge 240 of the mild steel main body. Details of tooth 220 are shown in FIGS. 10-13. Details of an alternative embodiment of a tooth 720 are shown in FIGS. 22-25. Each tooth 220, 720 may be cast from a white cast iron material with excellent wear resistance properties that are better than the wear resistance of the mild steel main body of the cutting edge component. As best seen in FIGS. 10 and 12, a front-facing surface of each tooth may include one or more grooves 233 extending inward from a front side surface 238 of tooth 220 along the front-facing surface in a U-shaped configuration, with each groove 233 intersecting the front-facing surface of the tooth along substantially parallel side edges 234 and an arcuate rear edge 235. Grooves 233 in teeth 220 enhance the penetration performance of the cutting edge component by providing sharp edges along the lines of intersection of the grooves with the front-facing surface of each tooth, and by increasing the total length of the edge actually coming into contact with ground. In the alternative embodiment of tooth 720, and as shown in FIGS. 22-25, substantially planar, intersecting brazing surfaces 731, 732 may be formed along rearward-facing surfaces of tooth 720, and a front-facing surface of each tooth 720 may include a portion 740 substantially perpendicular to a direction of travel of the machine and a portion 730 that tapers in a rearward direction from portion 720 toward wear component 212. The front-facing surface of each tooth 720 may also include a centrally located ridge 733 formed along the length of the front-facing surface, with sloped surfaces 734, 735 extending from the ridge 733 laterally to side surfaces 739 of each tooth 720.

In various exemplary implementations according to this disclosure, each white cast iron tooth 220, 720 may be cast in a shape designed to mate along a distal, ground engaging edge 240 of an existing wear component 212, typically made from a mild steel. The teeth 220, 720 may be vacuum brazed directly to the ground engaging edge 240 of the main body of the wear component without the need for an intermediate mild steel base. The teeth 220, 720 may also be vacuum brazed directly to the ground engaging edge 240 without the need to perform any machining operations to the existing wear component 212, other than some fine finishing operations to clean up surfaces to be brazed. The custom cast shape of teeth 220, 720 conforming to the configuration of distal, ground engaging edge 240 of the main body of an existing wear component 212 also eliminates any requirement to weld an intermediate mild steel base to the ground engaging edge of the wear component. As shown in the perspective view of FIG. 10, and in the side elevation view of FIG. 11, an exemplary tooth 220 may be designed with two flat brazing surfaces 231, 232 oriented in planes that intersect with each other at an obtuse angle corresponding to an angle of a chamfered surface along distal, ground engaging edge 240 of the main body of an existing wear component 212. As shown in FIG. 3, intersecting brazing surfaces 231, 232 of each tooth 220 may be configured to mate with a rearward-facing surface and a chamfered surface extending between the rearward-facing surface of wear component 212 and distal, ground engaging edge 240.

In an alternative embodiment, intersecting brazing surfaces 731, 732 of each tooth 720 may be configured to mate with a front-facing surface of wear component 212 and distal, ground engaging edge 240. Embodiments including teeth 720 brazed along a front-facing surface of wear component 212 may be able to withstand higher loads during an earth moving operation on larger machines as the loads impacting each tooth may be largely absorbed by wear component 212 and put less stress on the brazed joint.

In exemplary embodiments including teeth brazed along a rearward-facing surface of wear component 212, the front-facing surface of each tooth with groove 233 may be arranged approximately coplanar with a front-facing surface of the mild steel body when the tooth is brazed to the mild steel body. The term “approximately coplanar” refers to coplanar within standard machining, brazing, and other manufacturing and assembly tolerances. One of ordinary skill in the art will recognize that it is not required for the front-facing surface of each tooth 220 to be coplanar with the front-facing surface of the mild steel body of the wear component 212. Alternative implementations may include the front-facing surfaces of each of the teeth 212 extending an amount forward of the forward-facing surface of the main body of wear component 212, or even lying in a plane that is an amount rearward of the forward-facing surface of the mild steel body. Each of the brazing surfaces 231, 232 may be ground or otherwise finish machined to form a flat, smooth surface suitable for brazing to the wear component. In an exemplary embodiment, each of brazing surfaces 231, 232 may be ground to be flat within approximately 0.1 mm, and along with the mating surfaces on the wear component, may be finished so that any gap between the mating surfaces is less than approximately 0.2 mm. The process of vacuum brazing the white cast iron teeth 220 along the distal, ground engaging edge 240 of each wear component 212 may include control of a number of factors including, but not limited to, braze alloy selection, finish of the mating surfaces on both the white cast iron teeth and the mild carbon steel main body of the wear component, cleaning of the surfaces before a vacuum brazing operation, fixture design for holding the teeth against the wear component during the brazing operation, braze furnace environment, temperatures, and cycles, etc.

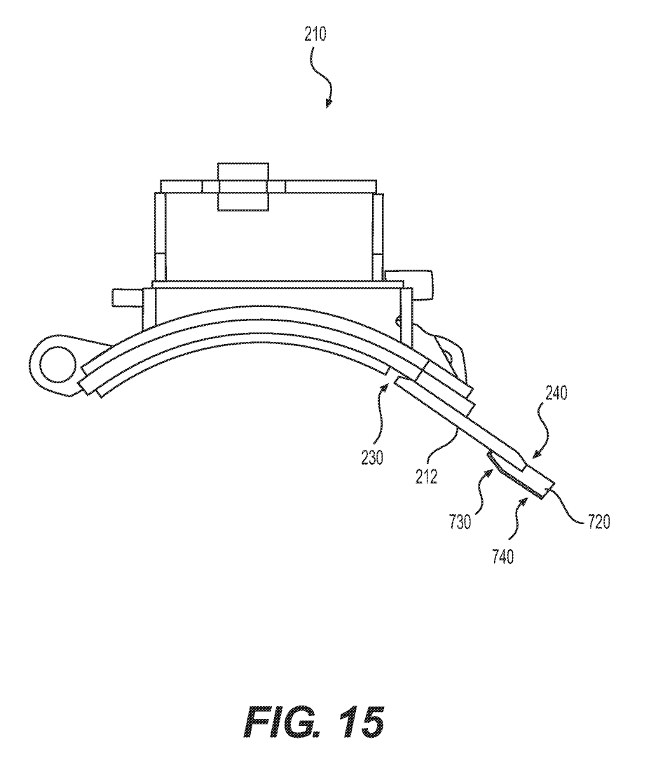

In the alternative embodiments shown in FIGS. 14-25, teeth 720 may be configured with a front-facing surface that includes portion 740 extending substantially perpendicular to the direction of travel, and portion 730 tapering from portion 740 in a rearward direction toward wear component 212, as best seen in FIG. 15. The front-facing surface of each tooth 720 may include the centrally located ridge 733 and sloped surfaces 734, 735, which form material directing features defined in the front-facing surface of each tooth when the tooth is brazed to the mild steel body of wear component 212. The ridges 733 and sloped surfaces 734, 735 of teeth 720, and the one or more grooves 233 extending inward from a front side surface 238 of teeth 220 along the front-facing surface in a U-shaped configuration, form material directing features along the front-facing surface of teeth 720, 220. These material directing features may improve the penetration performance of teeth 720, 220, while also increasing wear life of the wear components and reducing loads and stresses on the brazed joints between the teeth and the distal, ground engaging edge of wear component 212.

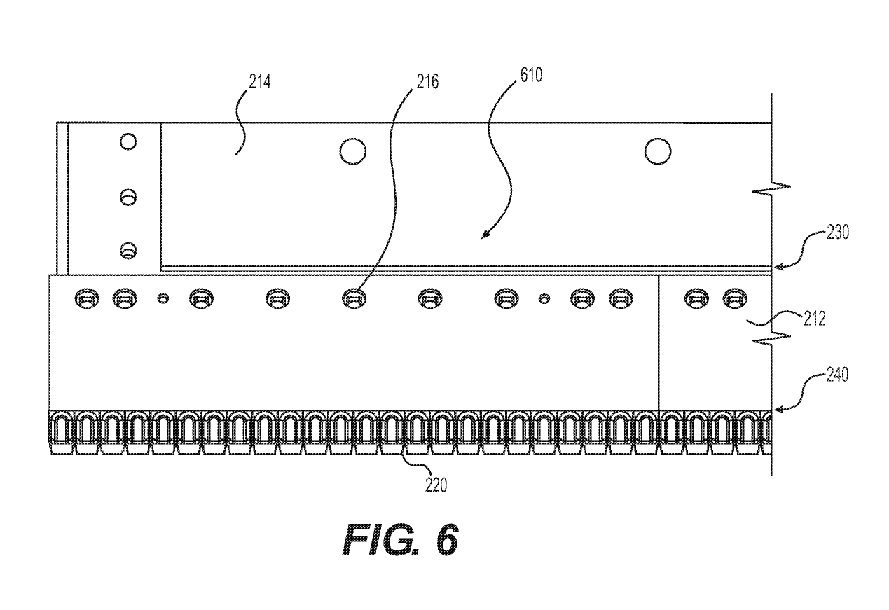

The various disclosed embodiments of cutting edge components with white cast iron teeth vacuum brazed along a distal, ground engaging edge 240 include different configurations and arrangements of the teeth 220 along distal, ground engaging edge 240. In the exemplary embodiments of FIGS. 4, 7, 16, and 19, individual teeth 220, 720 are brazed along distal, ground engaging edge 240 of cutting edge component 410, 420, with each tooth 220, 720 being spaced a selected distance from an adjacent tooth 220, 720. In alternative embodiments shown in FIGS. 5, 8, 17, and 20, teeth 220, 720 are arranged in pairs along distal, ground engaging edge 240 of cutting edge component 510, 520 with the two teeth 220, 720 in each pair of teeth contacting each other, and with a selected space provided between each of the pairs of teeth. In yet another alternative embodiment shown in FIGS. 6, 9, 18, and 21, teeth 220, 720 are arranged along distal, ground engaging edge 240 of cutting edge component 610, 620 with each tooth 220, 720 contacting and abutting against an adjacent tooth along the entire longitudinal extent of the cutting edge component such that there are no spaces between the individual teeth 220, 720.

The brazing surfaces 231, 232 of each tooth 220, and the brazing surfaces 731, 732 if each tooth 720 may be arranged with a stress-relieving, arcuate-shaped recess 237, 737 or groove formed at the intersections of the brazing surfaces with each other and with a surface of tooth 220, 720 designed to contact the distal, ground engaging edge 240 of wear component 212. The arcuate-shaped recesses 237, 737 may be designed to eliminate any high stress regions that may develop at sharp-angled intersections between cast surfaces on the white cast iron teeth 220, 720.

As best seen in FIGS. 10 and 12, and as discussed above, each tooth 220 may include one or more grooves 233 provided in a front-facing surface of a substantially planar portion of tooth 220. Each groove 233 may extend inwardly along the front-facing surface of tooth 220 from a distal edge of tooth 220 in a direction toward distal edge 240 of wear component 212 along which each tooth 220 is brazed. Each groove 233 may extend along a majority of a lateral length of the portion of tooth 220 subjected to wear as wear component 212 contacts a surface being graded. The proximal end of each groove 233 may be located near a middle portion of tooth 220 in the lateral direction. As shown in FIGS. 10, 12, and 13, each groove 233 may be generally U-shaped with a bottom surface and sides, and may have a depth that may be relatively shallow compared to a total thickness of the wear portion of tooth 220. The bottom surface of each groove 233 may be substantially parallel to the front-facing surface of tooth 220. In an embodiment, the depth of groove 233 may be approximately 5%-30% of the total thickness of the wear portion of tooth 220.

The sides of the grooves 233 may form edges 234, 235 with the front-facing surface of tooth 220. The edges 234, 235 may serve as self-sharpening teeth as wear progresses on the front-facing surface of tooth 220. As the front-facing surface of tooth 220 wears away, unworn and sharpened portions of edges 234, 235 become exposed, and therefore edges 234, 235 may be self-sharpening.

In some embodiments, the enhanced wear resistance of the white cast iron teeth 220, 720 may be still further enhanced by coating grooves 233, and ridges 733 formed along the front-facing surface of each tooth with a coating of abrasion resistant material. For example, the bottom surfaces, sides, and/or edges 234, 235 of grooves 233 may be coated with the abrasion resistant material. The abrasion resistant material may include a carbide (e.g., tungsten carbide, titanium carbide, and/or chromium carbide) and/or a metal oxide (e.g., aluminum oxide and/or chromium oxide). The abrasion resistant material, e.g., in particle form, may be applied to the grooves 233 by welding, plasma transfer arc deposition, and/or laser deposition. In some exemplary embodiments, the coating may not fill in grooves 233, thereby allowing grooves 233 to maintain the profile of the bottom surface, sides, edges 234, 235, and depth. Alternatively, the coating may fill the grooves 233.

As shown in FIGS. 11 and 13, each tooth 220 may have a width that may taper along a front side surface 238 of tooth 220 toward the front-facing surface of tooth 220, and along lateral side surfaces 239 toward the front-facing surface of tooth 220 with groove 233. Front side surface 238 and lateral side surfaces 239 may be oriented at angles ranging from approximately 0 degrees to approximately 15 degrees relative to a plane that is perpendicular to the front-facing surface of tooth 220. The tapering of teeth 220 toward either the front-facing surface or the opposite rearward-facing surface 236 of each tooth 220 may improve a cutting efficiency of the cutting edge component including teeth 220 by reducing drag forces or friction caused by the material flowing against the side surfaces of each tooth 220. Similarly, as shown in FIGS. 23 and 25, each tooth 720 may have a width that may taper along a front side surface 738 of tooth 720 toward the front-facing surface of tooth 720, and along lateral side surfaces 739 toward the front-facing surface of tooth 720 with ridge 733 and sloped surfaces 734, 735. Front side surface 738 and lateral side surfaces 739 may be oriented at angles ranging from approximately 0 degrees to approximately 15 degrees relative to a plane that is perpendicular to the front-facing surface of tooth 720. The tapering of teeth 720 toward either the front-facing surface or the opposite rearward-facing surface 736 of each tooth 220 may improve a cutting efficiency of the cutting edge component including teeth 720 by reducing drag forces or friction caused by the material flowing against the side surfaces of each tooth 720.

### INDUSTRIAL APPLICABILITY

The disclosed cutting edge components with wear portions that include white cast iron teeth 220, 720 brazed along a distal, ground engaging edge 240 of an existing mild steel wear component 212 may be applicable to any machine having a ground engaging tool. Several advantages may be associated with the cutting edge components according to various embodiments of this disclosure. The cutting edge components may exhibit improved penetration performance and longer wear life. For example, the cutting edge components may penetrate and break up hard and/or frozen ground, and may direct the flow of material passing by the cutting edge component when the cutting edge component is moved horizontally and/or vertically into the ground. Additionally, the disclosed embodiments with white cast iron teeth 220, 720 vacuum brazed along the distal, ground engaging edge 240 of an existing wear component 212 eliminate the need for an intermediate mild steel base to which the teeth must first be attached before the base can then be attached to an existing wear component, and eliminate any requirement to weld to existing support surfaces on wear components. Moreover, the custom cast shapes of the teeth enable mating and vacuum brazing of the teeth directly to existing cutting edge parts, with the cast shape providing improved sharpness, reduced soil cutting forces, improved flow of material past the teeth on the wear portions of the cutting edge component, and improved cutting efficiency of the disclosed cutting edge components.

The cast teeth 220, 720 of the wear portions on the cutting edge components may each have brazing surfaces formed along portions of the teeth that mate with either chamfered rearward-facing surfaces of an existing wear component 212, or a front-facing surface of an existing wear component 212. A front-facing surface of each tooth 220 may include material directing features such as one or more of at least one of a centrally positioned groove 233 that intersects with the front-facing surface along edges that provide self-sharpening cutting edges for each tooth, and a centrally positioned ridge 733. The grooves 233 and ridges 733 also increase the length of contact between the front-facing surface of each tooth 220, 720 and the ground being operated on by the cutting edge components, thereby increasing penetration force for the same amount of power expended in moving the cutting edge components through the soil. The custom cast shapes of teeth 220, 720 along the distal, ground engaging edges of wear components 212 may include tapered side surfaces extending between a rearward-facing surface of each tooth and the front-facing surface. The tapering of the width and/or thickness of each tooth 220, 720 along the sides of the tooth may form a chisel-like member at the ground engaging edge for penetrating and breaking up hard and/or frozen ground, e.g., when the cutting edge components 410, 510, 610, 420, 520, 620 with teeth 220, 720 move horizontally and/or vertically into the ground. Cast teeth 220, 720 may also be spaced along a distal, ground engaging edge of each cutting edge component in different configurations and spacings to achieve different results and/or to provide more effective penetration of different ground materials.

The arrangements of the cast teeth 220, 720 along the distal, ground engaging edge of each cutting edge component 410, 510, 610, 420, 520, 620 may include individual teeth 220, 720 that are each spaced a selected distance from an adjacent tooth, pairs of teeth 220, 720 that are arranged with each of the two teeth in each pair of teeth positioned immediately adjacent to each other, and with each pair of teeth being spaced a selected distance from an adjacent pair of teeth, and all teeth along the ground engaging edge being immediately adjacent and abutting against each other. The spacing of the teeth from each other, or the spacing of different groups of teeth from each other, along with the amount of taper of the sides of the teeth may be selected to allow the flow of material that is broken up by the ground engaging edge to pass between the teeth. The widths and spacing of the teeth 220, 720 may be different depending on the intended function of the cutting edge component as well as the dimensions of an existing wear component 212 to which the teeth 220, 720 are to be brazed. Also, the spacing (e.g., the width of the gaps between the teeth) of the teeth 220, 720 of the cutting edge components 410, 510, 610, 420, 520, 620 may depend at least in part on the size of the particles of the material broken up by the ground engaging edge.

The cutting edge components 410, 510, 610, 420, 520, 620 may also be constructed for optimal placement of the white cast iron teeth 220, 720 along the ground engaging edge 240 of a wear component 212 to reduce weight, cost, and the amount of material at the end of life of the cutting edge components. The custom cast shape of each tooth 220, 720 may be selected to optimize the penetration capabilities of the tooth and the wear life of the tooth, while minimizing costs associated with the amount of material and processing required to form each tooth.

It will be apparent to those skilled in the art that various modifications and variations can be made to the disclosed cutting edge components. Other embodiments will be apparent to those skilled in the art from consideration of the specification and practice of the disclosed cutting edge components. It is intended that the specification and examples be considered as exemplary only, with a true scope being indicated by the following claims and their equivalents.

What is claimed is:

1. A cutting edge component for a work tool on an earth-moving machine, the cutting edge component comprising:
a longitudinally-extending wear component and a support surface connectable to a moldboard of the earth-moving machine, wherein the wear component includes at least one wear portion connected to the support surface, and the at least one wear portion forms at least one ground engaging edge;
the at least one wear portion including a mild steel body and a plurality of longitudinally-spaced white cast iron teeth vacuum brazed along a distal, ground engaging edge of the mild steel body; and
the plurality of teeth each being shaped with two intersecting substantially planar surfaces arranged to mate with at least a surface extending between the distal, ground engaging edge and at least one of a rearward-facing surface of the mild steel body and a front-facing surface of the mild steel body on at least one of a side of the mild steel body facing away from a direction of travel of the machine and a side of the mild steel body facing in a direction of travel of the machine to form a brazed joint, and each tooth also including a material directing feature defined along a front-facing surface of each tooth when the tooth is brazed to the mild steel body.

2. The cutting edge component of claim 1, wherein the plurality of teeth are arranged individually along the distal, ground engaging edge of the mild steel body with a selected space between each of the teeth.

3. The cutting edge component of claim 1, wherein the plurality of teeth are arranged in spaced pairs along the distal, ground engaging edge of the mild steel body, with the two teeth of each pair in contact with each other, and with a selected space between each pair of teeth.

4. The cutting edge component of claim 1, wherein the plurality of teeth are arranged with each tooth in contact with an immediately adjacent tooth along the entire distal, ground engaging edge of the mild steel body.

5. The cutting edge component of claim 1, wherein each tooth includes a single, centrally located, U-shaped groove defined in the front-facing surface and intersecting the front-facing surface of the tooth along substantially parallel side edges and an arcuate rear edge.

6. The cutting edge component of claim 5, wherein the parallel side edges and arcuate rear edge at the intersection of the U-shaped groove and the front-facing surface of the tooth form self-sharpening cutting edges as the front-facing surface of the tooth is worn away.

7. The cutting edge component of claim 1, wherein each of the plurality of teeth includes tapered side surfaces extending between the front-facing surface and an opposite rearward-facing surface.

8. The cutting edge component of claim 7, wherein the tapered side surfaces of each tooth are oriented at angles ranging from approximately 0 degrees to approximately 15 degrees relative to a plane that is perpendicular to the front-facing surface of the tooth.

9. The cutting edge component of claim 1, wherein an arcuate-shaped recess is formed at the intersection of the two substantially planar surfaces of each tooth.

10. A wear component for a work tool on an earth-moving machine, comprising:
at least one wear portion including at least one ground engaging edge;
the at least one wear portion including a mild steel body and a plurality of longitudinally-spaced white cast iron teeth vacuum brazed along the at least one ground engaging edge; and
the plurality of teeth each being shaped with two intersecting substantially planar surfaces arranged to mate with at least a surface extending between the at least one ground engaging edge and at least one of a rearward-facing surface of the mild steel body and a front-facing surface of the mild steel body on at least one of a side of the mild steel body facing away from a direction of travel of the machine and a side of the mild steel body facing in the direction of travel of the machine to form a brazed joint, and each tooth also including a material directing feature defined in a front-facing surface of each tooth when the tooth is brazed to the mild steel body.

11. The wear component of claim 10, wherein the plurality of teeth are arranged individually along the at least one ground engaging edge with a selected space between each of the teeth.

12. The wear component of claim 10, wherein the plurality of teeth are arranged in spaced pairs along the at least one ground engaging edge with the two teeth of each pair in contact with each other, and with a selected space between each pair of teeth.

13. The wear component of claim 10, wherein the plurality of teeth are arranged with each tooth in contact with an immediately adjacent tooth along the entire ground engaging edge.

14. The wear component of claim 10, wherein each tooth includes at least one of a U-shaped groove and a ridge defined along the front-facing surface.

15. The wear component of claim 14, wherein the U-shaped groove includes parallel side edges and an arcuate rear edge at the intersection of the U-shaped groove and the front-facing surface of the tooth which form self-sharpening cutting edges as the front-facing surface of the tooth is worn away.

16. The wear component of claim 10, wherein each of the plurality of teeth includes tapered side surfaces extending between the front-facing surface of the tooth and an opposite rearward-facing surface of the tooth.

17. The cutting edge component of claim 7, wherein the tapered side surfaces of each tooth are oriented at angles ranging from approximately 0 degrees to approximately 15 degrees relative to a plane that is perpendicular to the front-facing surface of the tooth.

18. A method of forming a cutting edge component for a work tool on an earth-moving machine, the method comprising:
preparing a main body of an existing cutting edge component for vacuum brazing;
casting a plurality of white cast iron teeth, wherein each of the plurality of teeth is shaped with two intersecting planar surfaces that form an angle with each other arranged to mate with at least a surface extending between a distal, ground engaging edge and at least one of a rearward-facing surface of the main body and a front-facing surface of the main body; and
vacuum brazing the plurality of white cast iron teeth along the distal, ground engaging edge and the surface of the main body.

19. The method of claim 18, wherein the plurality of white cast iron teeth are arranged individually along the distal, ground engaging edge of the mild steel body with at least one of no space between two adjacent teeth or a selected space between two adjacent teeth.

20. The method of claim 18, wherein the plurality of white cast iron teeth are arranged in spaced pairs along the distal, ground engaging edge of the mild steel body, with the two teeth of each pair in contact with each other, and with a selected space between each pair of teeth.
